(19) United States
(12) Patent Application Publication
(10) Pub. No.: US 2002/0060255 A1
(43) Pub. Date: May 23, 2002

(54) Dispensing head and assembly including the same

(76) Inventor: Jean-Francois Benoist, Lagny/Marne (FR)

Correspondence Address: Thomas L. Irving, FINNEGAN, HENDERSON, FARABOW,, GARRETT & DUNNER, L.L.P., 1300 I Street, N.W., Washington, DC, 20005-3315, US

(21) Appl. No.: 09/987,515

(22) Filed: Nov. 15, 2001

(30) Foreign Application Priority Data
Nov. 15, 2000 (FR) 00 14717

(51) Int. Cl. B05B 7/32

(52) U.S. Cl. 239/337; 239/469; 239/491; 239/507; 239/533.13; 239/602; 239/DIG. 12

(57) ABSTRACT

A dispensing head for actuating a dispensing element associated with a container and for dispensing product from the container is provided. The dispensing head may comprise a body configured to be mounted on the container, with the body at least partly defining a feed channel. A movable element may also be provided having a portion defining a dispensing orifice. The movable element may be movable between a first position, in which the dispensing orifice is in fluid communication with the feed channel, and a second position, lacking this fluid communication with the feed channel. An elastic element may also be provided and configured to cause at least one of the portion of the movable element and a part of the body to be elastically biased against the other of the portion of the movable element and the part of the body when the movable element is in the first position.

The present invention relates to a dispensing head for dispensing a product, such as a fluid product, in the form of a jet and/or spray, for example and to a dispenser equipped with such a dispensing head. Another aspect relates to a dispensing head comprising means that facilitate cleaning in the event of clogging.

One form of a conventional dispenser includes a reservoir containing product that is to be dispensed and being equipped with an open end on which a dispensing member may be fixed. Such a dispensing member may be a pump or a valve. A dispensing head may be mounted on the dispensing member. A dispensing head of this type might fulfill at least two functions. On the one hand, it may allow the user to operate the dispensing member, so as to eject a dose of product from the reservoir. On the other hand, it may allow the product leaving the reservoir to be fed to a dispensing orifice.

Generally, such a dispensing orifice may be provided in the form of a nozzle, connected to the dispensing member via a feed conduit in the dispensing. The product may then be dispensed in, for example, the form of a somewhat string-like jet, or alternatively in the form of a cloud of fine droplets, known as a spray. The product may be fed to the dispensing orifice by simple pressure on a compressible product reservoir. Alternatively, when the dispenser is equipped with a dispensing valve, the reservoir may contain, apart from the product, a pressurized gas for propelling the product that is to be dispensed through the dispensing orifice.

Conventionally, a dispensing head for dispensing a liquid product may comprise a body equipped with a feed conduit in communication with the product reservoir. This conduit may communicate with a dispensing nozzle equipped with an outlet orifice of small cross section. Customarily, a nozzle such as this may be an attached part fixed, at the time of manufacture, to the dispensing head in a non-removable way.

Certain products, for example products containing resins, have a tendency, after a long period of non-use, to clog the channels carrying product and/or the dispensing nozzle, for example with dry product residues. Now, with the dispensers currently on the market, it is practically impossible to unblock or clean the nozzle and/or the feed conduit, without causing damage to the dispensing head. This damage is usually detrimental to the subsequent functioning of the dispenser.

The clogging phenomenon may occur quite often when the product is, for example, a solution or a dispersion that readily dries out in ambient air. Such products may include spray adhesives, or products for treating the hair and/or the skin, such as hair lacquers or sunscreen products, although this list is not intended to be comprehensive.

Even in some arrangements where it is possible to remove and re-attach the nozzle, it has proven difficult to readjust the nozzle on the feed conduit after it has been refitted, which renders it difficult to obtain a constant quality of spray after cleaning.

Optionally, the present invention may solve one or more of the aforementioned problems by making available a dispensing head that can easily be cleaned, without complicated disassembly. For example, dispensing head may have a structure that makes it possible to fit or refit the nozzle relative to the feed conduit with a precise and reproducible adjustment and also with reliable leaktightness. Certain exemplary embodiments may provide a cleanable dispensing head capable of ensuring, throughout its period of use, the production of a jet and/or a spray, in fine droplets of constant quality.

According to a first aspect, a dispensing head is provided for actuating a dispensing element, such as a valve, fitted on a container that may contain a product to be dispensed. The dispensing head may be configured to dispense the product via at least one dispensing orifice. The dispensing head may comprise a body at least partly defining a feed channel and being intended for mounting the head on the container. The dispensing head may also include an element in which the dispensing orifice may be formed. The element may be movable between a first position in which the dispensing orifice may be in communication with the feed channel, and a second position in which said communication may be interrupted. An elastic means may also be provided which, when said element is in the first position, may ensure an elastic bearing between the body and said movable element.

In an exemplary embodiment, the elastic bearing between the body and the movable element is arranged so that after the dispensing head has been disassembled and the feed channel has been cleaned, it may be possible to reposition the dispensing orifice at least substantially in its initial position relative to an end portion of the feed channel. This repositioning may thereby ensure reproducibility of dispensing qualities, and/or spraying qualities, of the dispensing head.

For some exemplary uses of the dispensing device the positioning of the dispensing orifice may be desired for obtaining a particular quality of spray. In certain circumstances, a slight imprecision in repositioning, for example after cleaning, of the dispensing orifice relative to the feed channel may lead to deterioration in the original properties of the spray.

According to one aspect, the elastic means may be arranged in such a way that it is capable of exerting a return force parallel to an exit axis of the product (passing through the dispensing orifice). The dispensing orifice may also be formed in a spray nozzle which is, for example, integral with the movable element.

According to an aspect, the feed channel may define, in cooperation with the movable element when the latter is in the first position, a swirl chamber for communicating with the dispensing orifice. Likewise, at least part of the remainder of the feed channel may be defined at least partly by the movable element and at least partly by the body. The swirl chamber may also be provided with what is commonly called a center post, which, in cooperation with the movable element when the latter is in the first position, may delimit said swirl chamber.

A swirl chamber may generally be a recess situated directly upstream of the dispensing orifice and supplied via a plurality of conduits forming part of the feed channel and opening tangentially into the swirl chamber. This swirl chamber and the tangential conduits may also be hollowed out on the body or possibly on a front face of the center post.

Alternatively, the swirl chamber and the tangential conduits may be engraved on the movable element, and possibly on an inner face of the movable element that is configured to come into contact with the body. Such a swirl chamber may be able to confer on the flow of the product, just before passing through the dispensing orifice, a movement of acceleration in the form of a converging spiral, making it possible for the product to break up into particularly fine droplets after it has passed through said dispensing orifice. This effect may be useful, for example, when using a precompression pump or a dispensing valve in combination with a compressed propellant gas not soluble in the product. If appropriate, the valve may be a valve for additional gas, well known in the prior art.

According to one aspect, the center post may project from a surface of the body situated opposite the dispensing orifice.

According to another aspect, the elastic means may be integral with the movable element. Thus, the elastic means can possibly be formed by an elastically stretchable membrane arranged at a distance, substantially around a perimeter of the dispensing orifice. This membrane could be in the form of an annular element. For this purpose, in this configuration, the elasticity of the membrane may be such that, when the movable element is in the first position, a portion of the movable element situated inside the ring delimited by the membrane, and in which the dispensing orifice is formed, may bear elastically on the center post.

According to another aspect, the elastic means might be made integral with the body and can possibly form part of the center post. Thus, the center post may be at least partly elastically compressible in a direction parallel to the exit axis of the product.

In the two configurations above, the elastic means may be made from an elastomeric material such as, for example, at least one of thermoplastic elastomers of polyester urethane (AU), polybutadiene (BR), bromobutyl (BIIR) or chlorobutyl (CIIR) rubbers, chlorinated polyethylene (CM), copolymers of polyester-aramide (CPA), copolymers of polyester glycol (CPE), polychloroprene (CR), chlorosulphonated polyethylene (CSM), copolymers of ethylene and methyl acrylate (EAM), terpolymers; of ethylene, propylene and a diene (EPDM), copolymers of ethylene and propylene (EPM), polyether urethanes (EU), fluorocarbonated copolymers or terpolymers (FKM, FPM), butyl rubber (IIR), polyisoprene (IR, NR), nitrile rubber (NBR), polyurethanes (PUR), phenyl- or vinyl-methylsilicones (PVMQ), copolymers of styrene-butadiene (SBR), block copolymers of styrene-butadiene (SBS), block copolymers of styrene-butadiene-butylene-styrene (SEBS), block copolymers of styrene-isoprene (SIS), synthetic rubbers (SR), polysulphides (TM), thermoplastic rubbers (TPE), elastomeric thermoplastic polyolefin derivatives (TPO), thermoplastic polyurethanes (TPU), polyvinyl silicones (VMQ), and latex of copolymers of butadiene-styrene-2-vinylpyridine (VP).

From a practical point of view, the dispensing head may be produced by bi-injection (e.g., duplicate moulding) of a thermoplastic elastomer, forming the elastic means, and of a nonelastomeric material, forming the rest of the dispensing head.

It is also possible to produce the dispensing head from a single plastic material. In this case a suitable thermoplastic material may comprise, for example, at least one of polyethylene (LDPE/HDPE), block copolymers of styrene-butadiene (SBS), copolymers of propylene-ethylene (PP/PE), polypropylene (PP) and polyamides (PA). This composition may then make it possible to produce the elastic means in the form of a zone, for example annular area, of lesser thickness inside which the dispensing orifice may be formed. This zone of lesser thickness may be capable of deforming elastically in a direction parallel to the exit axis of the product when the movable element passes from the second position to the first position.

Sealing means may additionally be provided to ensure a suitable leaktightness between the body and the movable element when the latter is in the first position. Such a sealing means may be made in the form of a flange/groove system arranged, for example, in a continuous manner, around parts forming the feed channel. Thus, a flange may be formed on the body, capable of cooperating with a complementary groove of the movable element, or vice versa, when the latter is in the first position.

Alternatively, the sealing means may be made in the form of an elastically compressible cord arranged around parts forming the feed channel. This cord may be formed either on the body or on the movable element. The cord may also be slightly prominent in relation to the body or the movable element.

A change-over from the first position to the second position of the movable element, and vice versa, could be effected by a pivot movement of the movable element about an axis perpendicular to the exit axis of the product. In this case, the movable element may be articulated on said body with the aid of a hinge. This hinge may comprise, for example, a film hinge or a journal hinge. A fastening/locking means may also be provided in order to lock the movable element reversibly in the first position.

Another aspect may relate to an assembly for packaging and dispensing a product, for example, a cosmetic product. The assembly may be provided with a dispensing element, such as a pump or a valve, and may be equipped with a dispensing head as described herein.

If the assembly comprises a dispensing valve, product to be dispensed may be fed to the valve, for example, by way of a pressurized propellant gas. The propellant gas may act directly or indirectly on the product contained in a reservoir which communicates with the valve.

The dispensing head according to the invention may also be configured to act as a push button with a bearing surface on which the user may press to trigger ejection of a dose of product.

According to another aspect, a dispensing head for actuating a dispensing element associated with a container and for dispensing product from the container is provided. The dispensing head may comprise a body configured to be mounted on the container, with the body at least partly defining a feed channel. A movable element may also be provided having a portion defining a dispensing orifice. The movable element may be movable between a first position, in which the dispensing orifice is in fluid communication with the feed channel, and a second position, in which the dispensing orifice lacks fluid communication with the feed channel. An elastic element may also be provided and configured to cause at least one of the portion of the movable element and a part of the body to be elastically biased against the other of the portion of the movable element and the part of the body when the movable element is in the first position.

According to another aspect, the dispensing orifice and an exit end of the feed channel may define a product exit path, wherein the elastic element may be configured to exert a force substantially parallel to the product exit path. In addition, the elastic element may also be configured to elastically bias said at least one of the portion of the movable element and the part of the body in a direction substantially parallel to the product exit path.

According to another aspect, the dispensing head may further comprise a post defining at least some of an exit end portion of the feed channel. In an optional aspect, the post may comprise said part of the body. In another optional aspect, the post may have a surface contacting the portion of the movable element when the movable element is in the first position.

In one aspect, the elastic element may comprise an elastically stretchable membrane arranged substantially around a perimeter of the portion of the movable element defining the dispensing orifice. Optionally, the membrane may comprise a substantially annular element.

In another aspect, the elastic element may comprise an elastically stretchable membrane arranged substantially around a perimeter of the portion of the movable element defining the dispensing orifice, and wherein the elasticity of the membrane is configured so that, when the movable element is in the first position, the portion of the movable element defining the dispensing orifice is biased elastically against the post.

In yet another aspect, the elastic element may be integral with the post and configured to allow the post to be at least partly elastically compressible in a direction substantially parallel to a product exit path defined by the dispensing orifice and an exit end of the feed channel.

In an aspect, at least part of the elastic element is less thick than at least a portion of the dispensing head in contact and integral with the elastic element.

According to another aspect, the dispensing head may further comprise a sealing system configured to create a substantially leak-proof seal between the body and the movable element. Optionally, the sealing system may comprise an elastic sealing element configured to protrude from at least one of the body and the movable element so as to be compressed between the movable element and the body when the movable element is in the first position to create the leak-proof seal. In addition, this sealing element may be located on the body or the movable element.

In another aspect, the sealing system may comprise a flange located on one of the body and the movable element, and a complementary groove located on the other of the body and the movable element, wherein the flange and the groove are configured to mate to form the substantially leak-proof seal.

In one aspect, the movable element and body may be coupled to one another so that the movable element moves between the first position and the second position via a pivot movement about an axis substantially perpendicular to a product exit path defined by the dispensing orifice and an exit end portion of the feed channel.

In yet another aspect, the movable element may be coupled to the body when the movable element is in both the first position and second position.

The movable element may optionally be coupled to the body during movement between the first position and the second position.

In another aspect, the body and the movable element may cooperate to define at least some of the feed channel when the movable element is in the first position, and wherein said at least some of the feed channel may be cleaned when the movable element is in the second position.

In another aspect, an assembly for packaging and dispensing product is provided comprising a container associated with an actuatable dispensing element; and a dispensing head as described herein mounted on the container. Optionally, the assembly may further comprise a product contained in the container, wherein the product comprises a cosmetic product.

In another aspect, the dispensing element of the assembly may comprise at least one of a valve and a pump.

In one aspect, the dispensing element may configured to be movable to cause actuation of the dispensing element.

In yet another aspect, the dispensing head may be in the form of a push button.

The accompanying drawings are included to provide a further understanding of the invention and are incorporated in and constitute a part of this specification. The drawings illustrate exemplary embodiments of the invention and, together with the description, serve to explain certain principles. In the drawings,

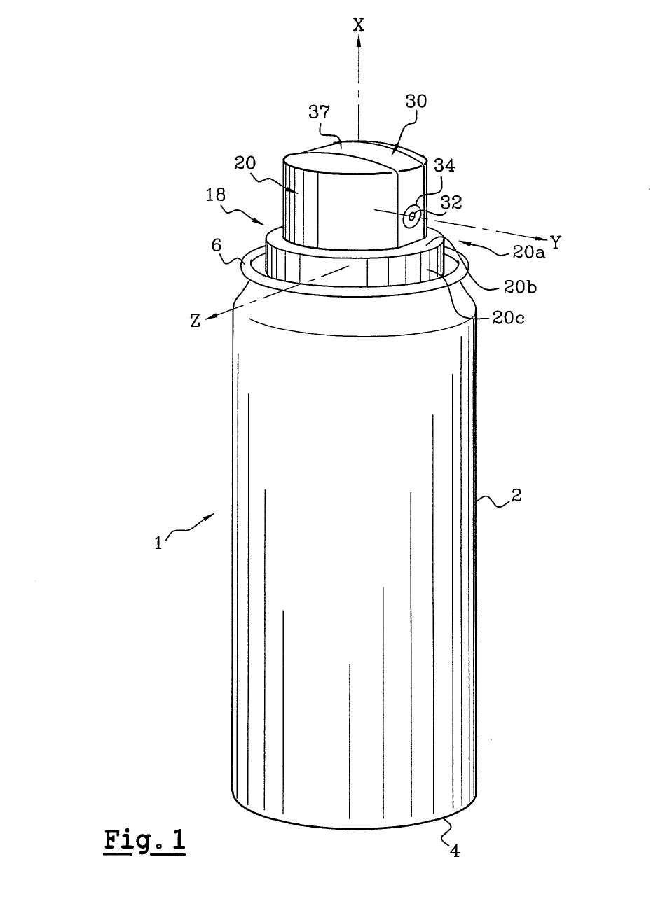

FIG. 1 is a perspective view of a dispensing assembly, equipped with a dispensing head, according to an exemplary embodiment;

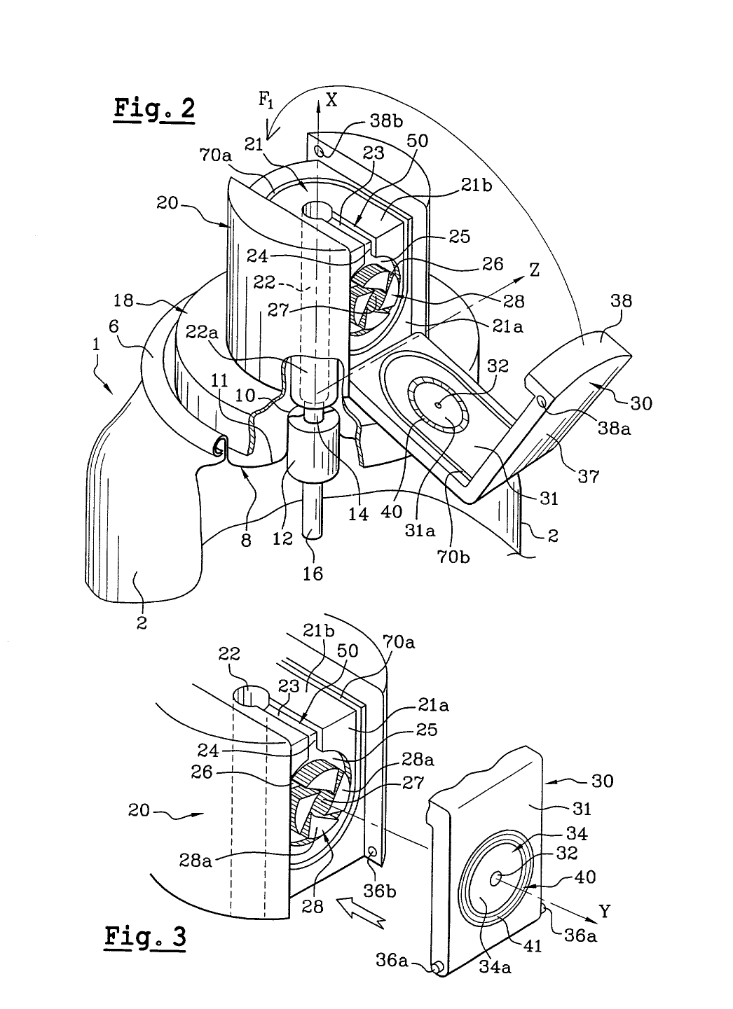

FIG. 2 is a perspective view of the dispensing head of FIG. 1, in an open position;

FIG. 3 is a diagrammatic exploded perspective view of the dispensing head of FIG. 1, in an assembly stage;

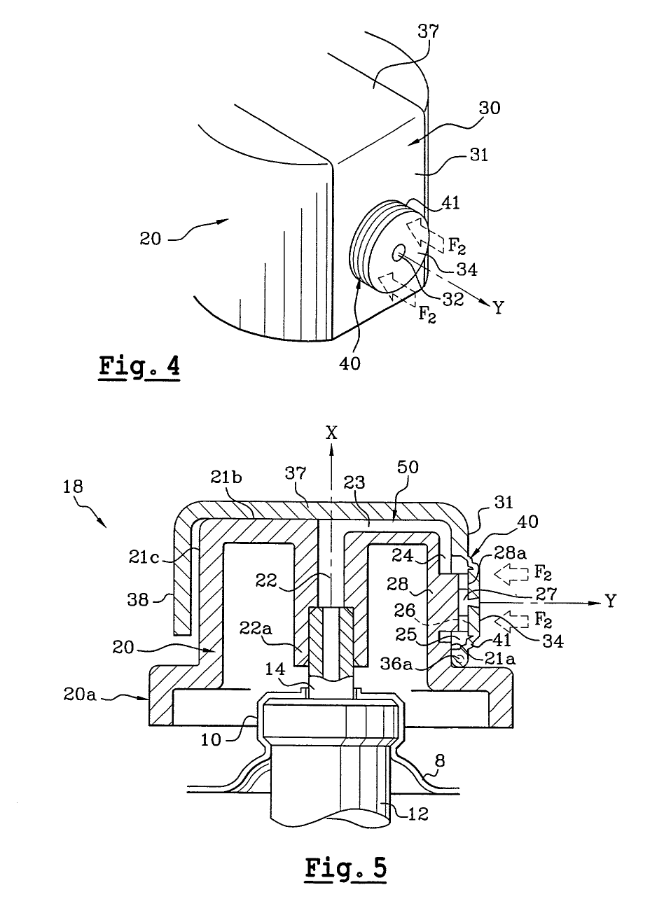

FIG. 4 is a perspective view of the dispensing head of FIG. 3, represented after assembly;

FIG. 5 a cross section view of the dispensing head shown in FIGS. 1 to 4;

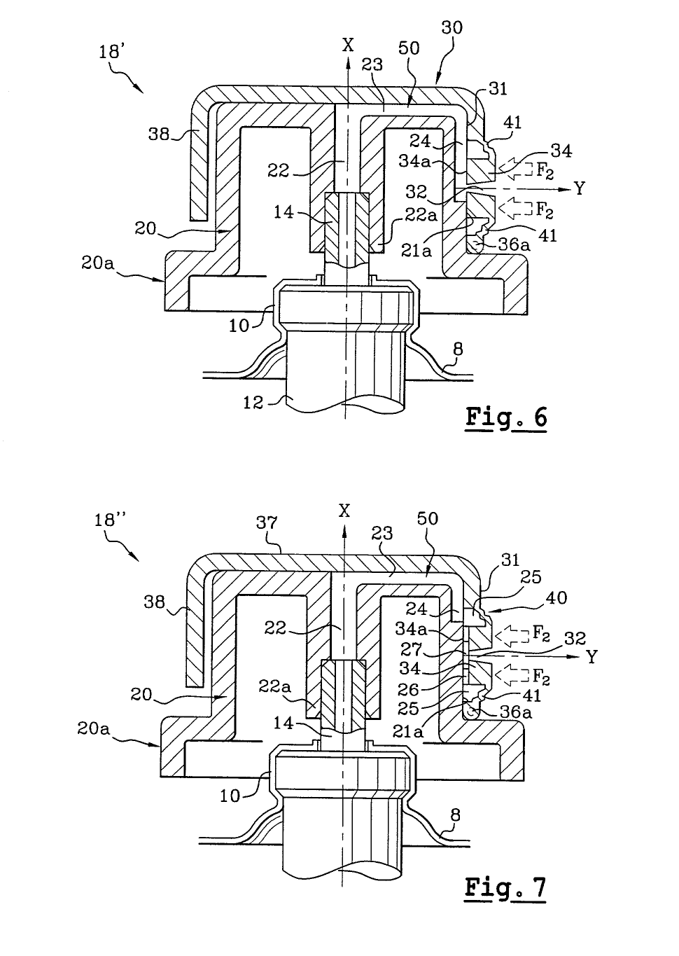

FIG. 6 is a cross section view of a dispensing head according to another exemplary embodiment;

FIG. 7 is a cross section view of a dispensing head according to yet another exemplary embodiment; and

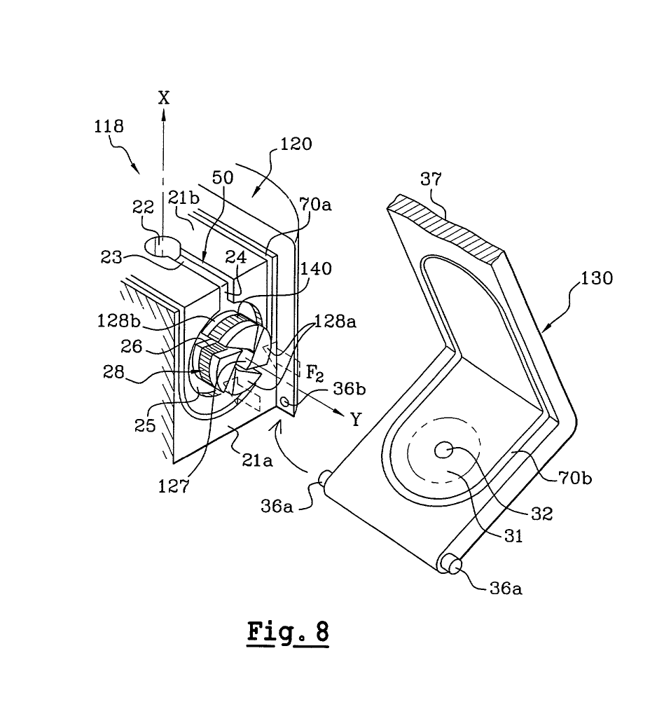

FIG. 8 is an exploded perspective view of a dispensing head according to yet another embodiment;

FIG. 9 is a cross section view of a dispensing head according to another exemplary embodiment showing a film hinge for connecting the movable part to the body.

Reference will now be made in detail to exemplary embodiments of the invention, examples of which are illustrated in the accompanying drawings. Wherever possible, the same reference numbers are used in the drawings and the description to refer to the same or like parts, and the same reference numbers with alphabetical suffixes are used to refer to similar parts. In addition, alternative embodiments of the dispensing head have been denoted by the same reference numbers followed by quotation marks.

With reference to at least FIGS. 1 to 5, reference number 1 has been generally used to denote a dispensing assembly according to a first exemplary embodiment of the invention. As can be seen in FIGS. 1 and 2, the dispensing assembly 1 comprises a cylindrical reservoir 2 in which a liquid product, such as a hair spray, may be packaged. The reservoir 2 may be in the form of a metal can and have an axis X. Product in the reservoir 2 may be pressurized using a propellant gas, for example, of the liquefiable and/or compressed type, stored in the reservoir 2.

The reservoir 2 has a cylindrical body, a closed base 4 and a rolled edge 6 defining, at its upper part, a circular opening. Fixed into this opening, for example by crimping or expansion rolling, is a cup 8 (see FIG. 2). The cup 8 at its center forms a cylindrical cavity 10 in which the body of a dispensing element 12, such as a valve or pump, is mounted. The cylindrical cavity 10 is surrounded by an annular zone of depression 11. A first end of the dispensing element 12 comprises an actuating stem 14 emerging outward and passing through the center of the cup 8, at the level of the cavity 10. The axis of the actuating stem 14 is coincident with the axis X of the reservoir.

Inside the reservoir 2, the second end of the dispensing element 12 is connected to a dip tube 16 extending substantially to the base 4 of the container. The dip tube 16 may make it possible to feed product, which may be contained in the reservoir, to the dispensing element 12. When the dispensing element 12 is a valve, the valve may be a male or female valve of, for example, the push-in type, or alternatively a valve that may be actuated by tipping the stem 14 sideways. In the case of a dispensing element 2 in the form of a pump, the movement of the stem 14, for example via axial reciprocation, may cause pumping of product through the stem 14.

Mounted on the free end of the valve stem 14 is a dispensing head 18, made in two parts 20, 30. A first part 20 forms the body of the dispensing head 18. The free end of the stem 14 is engaged in the body. For this purpose, the body 20 has tubular connection means 22a intended for fitting the body 20 with force onto the stem 14. The portion 22a constitutes an end portion of the channel 50. The channel 50 feeds the product from the stem to a dispensing orifice 32, as will be explained in detail below.

A pivoting or movable element 30 is mounted on the body 20 and is movable between a first position or closed position (FIGS. 1, 4 and 5) and a second position or open position (FIG. 2). The dispensing orifice 32 communicating with the feed channel 50 is formed in this pivoting element 30. The movable element 30 is attached to the body 20 and articulated on it via a pin hinge 36a/36b. A pivot axis Z is defined by the pins 36a.

It is conceivable, however, that this connection may be formed using a film hinge 136a as seen in FIG. 9. FIG. 9 differs from FIG. 5 only in the construction of the hinge, although film hinge 136a is not limited to use with dispensing head 18 and could be used with any embodiment contained herein. This thus makes it possible for the body 20 and the movable element 30 to be produced in one piece.

The movable element 30 constitutes an opening and closing member that may be opened to permit access to the different parts of the feed channel 50 of the dispensing head 18, and also to permit access to the inner face of the dispensing orifice 32. In this embodiment, the feed channel 50 is defined in part by the body 20 on the one hand and by the movable element 30 on the other.

The movable element has the general shape of a letter L, presenting a front face 31 that is substantially planar and whose lower end laterally carries the pins 36a of the hinge. Remote from the hinge, the front face 31 is connected to a plate 37 oriented perpendicular to the front face 31. The plate 37 ends in a bent-back portion 38 whose orientation is substantially parallel to the face 31.

The front face 31 of the movable element 30 comprises a spray nozzle 34 of generally circular shape. The center of the nozzle 34 is pierced to form the dispensing orifice 32. The spray orifice 32 may be a cylindrical hole with a diameter from approximately 0.15 mm to approximately 1 mm. The depth of this dispensing orifice 32 may be approximately 0.1 mm to approximately 1 mm.

The nozzle 34 is connected to the rest of the movable element 30 by an elastic element 40 which, according to the exemplary embodiment under consideration, is formed as an annular zone 41. This annular zone 41 may be made of an elastically stretchable material. The nozzle proper, that is to say the portion 34 in which the dispensing orifice is formed, may be made of a substantially rigid or semi-rigid material. The annular zone 41 surrounding it could be made of an elastomeric thermoplastic material, for example by bi-injection of the elastic material with a nonelastomeric material, such as a rigid to semi-rigid material, forming the rest of the movable element 30. In this embodiment, the nozzle 34 is “suspended” on the movable element 30 via the annular zone 41 and is elastically displaceable in the direction of the normal of the plane of the front face 31. In other words, an elastic displacement of the nozzle 34 may be affected in the direction of the exit path Y of the product through the dispensing orifice 32.

It is of course possible, without departing from the scope of the present invention, for the annular zone 41 to be made in one piece with the movable element 30, for example, in the form of a membrane of lesser thickness. Such an annular membrane 41 may form concentric undulations or a bellows (FIG. 3) which, when stressed, may promote the elastic displacement of the dispensing orifice 32 in the direction of the axis Y relative to the rest of the movable element 30. In this exemplary embodiment in which the movable element 30 is made from a single material, a semi-rigid material such as polyethylene may comprise the movable element 30.

The body 20 forms a base 20a defining a circular plate 20b. Arranged on the plate 20b is a cylindrical structure comprising a recess 21 designed such that the movable element 30 may be accommodated therein at least when the movable element 30 is in the first, or closed, position. The base 20a is defined by a peripheral skirt 20c that may be able to slide axially inside the cup 8 upon actuation of the dispensing element 12.

The recess 21 comprises a front part 21a intended to receive the front part 31 of the movable element 30. Recess 21 comprises an upper part 21b intended to receive the plate 37 of the movable element 30, and also a rear part 21c intended to receive the rear part 38 of the movable element 30. Thus, in the first position of the movable element 30, the front face 31 thereof lies on the front part 21a of the recess. Likewise, the plate 37 is positioned on the upper surface 21 b of the recess 21. The bent-back portion 38 of the movable element 30 is accommodated on the rear face 21c. The bent-back portion 38 thus constitutes a fastening means that may lock the movable element 30 temporarily in the first position. Moreover, as will be seen below, the plate 37 constitutes a bearing surface via which the user, by exerting axial pressure with a finger, may be able to actuate the dispensing valve 12.

Alternatively, or in addition, the plate 37 may comprise supplementary locking means 38a/38b, as are illustrated in FIG. 2. These supplementary locking means 38a/38b are formed here by lateral studs 38a on the movable element 30 which are able to cooperate, in the closed position of the assembly, with complementary hollow portions 38b provided on the sides of the recess 21.

The tubular connection means 22a to the stem 14 lead the product, via the part 22 of the feed channel 50, to the upper surface 21b of the recess 21. At this location, the portion 22 opens into a substantially radial channel portion 23, continued via an axial conduit 24 hollowed out in the front face 21a of the recess 21. In turn, the conduit 24 opens onto an annular portion 25 of the feed channel. Inside the annular portion, a center post 28 projects from the front face 21a of the recess 21. The center post has a front face 28a, at the center of which a swirl chamber 27 of circular cross section is hollowed out. A plurality of channels 26 open out tangentially on the swirl chamber 27, and are themselves in communication with the annular portion 25.

The swirl chamber 27 and the various parts of the feed channel 50 may be entirely closed when the movable element 30 is in the first position. In this position, the dispensing orifice 32 is substantially opposite the center of the swirl chamber 27. Where appropriate, the swirl chamber may promote good mixing of the product and the propellant gas and may confer on the product, as it is dispensed, a spiral movement converging toward the center of the swirl chamber 27, opposite the dispensing orifice 32. This may result in an acceleration of the product as it passes through the dispensing orifice 32, thus allowing the product to break up into substantially homogeneous particles, and giving a spray of good quality.

The provision of such a swirl chamber 27 may be suitable for spraying a product of low viscosity, pressurized in the reservoir 2, for example, by a propellant gas not soluble in the product. The propellant gas may be chosen from among the compressed gases (CO₂, nitrogen, compressed air), liquefied gases or their mixtures, although this list is not intended to be comprehensive.

To ensure good leaktightness or a substantially leak-proof seal between, on the one hand, the various portions of the feed channel 50 and swirl chamber 27 and, on the other hand, the movable element 30, sealing means 70a, 70b may be provided. Such sealing means may be in the form of a seal 70a of elastic material surrounding all the various portions of the feed channel 50, including the swirl chamber 27. The seal 70a may be slightly prominent and compressible when the movable element passes from the second position to the first position.

The term “substantially leak-proof” as used herein is intended to define a state of the device whereby a product seal is provided by the portion(s) of the device in the “substantially leak-proof” state. For example, when the product is a liquid, this seal could be a liquid tight seal. This product seal is intended to exist when the device is used in a manner consistent with the disclosure contained herein so as not to allow product to flow out of sealed portion(s) of the device. Optionally, this “substantially leak-proof” state may also at least inhibit the free flow of gas out of the device and/or provide an airtight arrangement whereby air does not normally enter through this “seal” at all.

Alternatively, the elastic seal 70a may comprise a system having a flange and a complementary groove arranged around the various portions forming the feed channel. Thus, a flange 70a can be formed on the body 20. The flange 70a may be capable of cooperating with a complementary groove 70b provided on the movable element 30 (see FIG. 3), or vice versa, when the latter is in the first position.

A dose of product P may be dispensed by actuation of the dispensing element 12 by simple pressure on the upper surface 37 of the dispensing head 18 when the dispensing element has a push-in valve stem or push-in pump stem, for example. In the case of a laterally tilting valve, the valve may be actuated by pressing laterally on the dispensing head.

After a dose of product has been dispensed, product residues may remain stuck in the feed channel 50, and also in the swirl chamber 27, for example, in proximity to the dispensing orifice 32. After a prolonged period of non-use, it may be possible for dry residues to form, for example through evaporation of a solvent contained in the product, or through oxidation of the product. This may create a risk of entirely or partially blocking the feed channel and/or the dispensing orifice 32.

When such blocking of the feed channel 50 and/or the swirl chamber 27 and/or the dispensing orifice 32 exists, cleaning of these parts may be necessary. For this purpose, the user may pivot the movable element 30 about the axis Z, after unclicking the fastening portion 38 and/or the supplementary locking means 38a/38b. To ensure a good grip between the user's fingers, a surface portion of the movable element 30 may have a nonslip profile.

On moving the movable element 30 away from the body 20, by pivoting the movable element 30 about the axis Z, the various parts of the feed channel 50, the swirl chamber 27, and the inside of the nozzle 34 are made accessible and may be cleaned. The two parts 20, 30, thus moved apart, may then be cleaned, for example, by mechanically removing the residues, or by rinsing, such as with water under a tap.

After drying, the movable element 30 may be repositioned on the body 20 by means of a pivoting movement in the direction of the arrow F₁ (FIG. 2), in a movement executed in the opposite direction to the direction of opening. In the closed position of the movable element 30 on the body 20, the inner wall of the nozzle 34 is biased elastically against the front face 28a of the center post. Thus, the dispensing orifice 32 lies in an elastic manner against the swirl chamber 27, by stretching of the elastic membrane 40. The elastic bearing of the nozzle 34 on the body 20 of the dispensing head, and more precisely on the front face 28a of the center post, is symbolized in FIGS. 4 and 5 by the arrows F₂.

For the exemplary embodiment of FIGS. 1-5, it should be noted that after cleaning the feed channel and/or the nozzle, the dispensing orifice 32 may be repositioned substantially exactly in the initial position relative to the swirl chamber 27, thereby ensuring substantially perfect reproducibility of the spray qualities of the dispensing head 18.

FIG. 6 illustrates an axial cross section through an embodiment of a dispensing head 18′ which is simplified in comparison to the previously described exemplary embodiment. This is because the dispensing head 18′ does not comprise a swirl chamber or center post. Thus, the various portions 22, 23, 24 of the feed channel 50 lead the product directly to the dispensing orifice 32. In the closed position of the dispensing head 18′, the inner face 34a of the movable element 30 bears elastically, in the direction of the arrows F₂, directly on a plane portion 21a of the body 20. For this purpose, and in the same way as in the previous exemplary embodiment, the dispensing orifice 32 may be formed at the center of a portion 34 connected to the movable element via a ring of elastically stretchable material 41. This elastically stretchable material 41 may have characteristics, for example stretch characteristics, such that in the position with the movable element 30 mounted on the body 20, the portion 34 may biased elastically against the portion 21a of the body 20.

FIG. 7 shows a dispensing head 18″ which differs from the exemplary embodiment previously described with reference to FIGS. 1 to 5 by the fact that the dispensing head 18″ does not have a center post. Compared to the dispensing head 18 (see in particular FIG. 5) in which the swirl chamber 27 and the tangential channels 26 are hollowed out in a portion integral with the body 20, in the dispensing head 18″ the swirl chamber 27 and the tangential channels 26 are hollowed out in the nozzle 34. The body 20 thus forms a planar front face 21a on which the inner face 34a of the nozzle 34 may be elastically biased. The swirl chamber 27 and the tangential channels 26 may be moulded on this inner face 34a.

In the closed position of the dispensing head 18″, the inner face 34a bears elastically, in the direction of the arrows F₂, directly on a plane portion 21a of the body 20. The tangential channels 26 may be in communication with an annular channel 25 formed between the plane portion 21a of the body 20 and the annular membrane 41. The annular channel 25 thus communicates with the stem via the portions 22, 23 and 24 of the feed channel 50. The dispensing heads 18′ and 18″ may be used and cleaned in a manner similar to the manner in which the dispensing head 18 is used and cleaned, as has been described above.

Another exemplary embodiment of a dispensing head 118 is shown in FIG. 8. The 20 structure of the dispensing head 118 is substantially similar to the structure of the dispensing head 18 of the first embodiment described above. The parts identical to those in FIGS. 1 to 5 bear the same reference numbers. Only those elements which differ will be described in detail below. The reference numbers of these elements have a number over 100.

The dispensing head 118 comprises a body 120 provided with a planar front face 21a. The front face 21a is provided with an annular channel 25 surrounding a center post 28 of generally cylindrical shape. The front face 28a of the center post protrudes slightly from the plane of the front face 121a. The center post 28 has a composite structure. It has a base of circular cross section 128b that radially defines the inner portion of the annular channel 25. The base 128b is formed in one piece with the body 120 and may be made of a relatively rigid thermoplastic material.

Arranged on the base 128b is a zone 140 made of, for example, an elastically compressible material. The elastically compressible zone 140 is covered by a plate 128a intended to bear elastically against the inner front face 31 of the movable element 130 when the latter is in the position locked on the body 120. In the locked position of the movable element 130, the elastically compressible zone 140 may be compressed so that the exposed face of the plate 128a comes into elastic contact with the movable element 130 and is substantially level with the front face 21a of the body.

Formed on the exposed face of the plate 128a are profiles that are able to define, with the movable element 130, the tangential channels 26 and the swirl chamber 27, such that the dispensing orifice 32 may be centered on the swirl chamber 27. The elastically compressible zone 140 of the center post 28 may be formed by any suitable means, for example, by multiple injection of a suitable elastomeric material on a substantially rigid material, then a substantially rigid material on the elastically compressible zone 140.

It is also conceivable that the compressible zone 140 may be incorporated into an embodiment similar to that depicted in FIG. 7. In such a configuration, compressible zone 140 could be formed between the inner face 34a and the portion of the movable element 30 that defines the dispensing orifice 32. In this configuration, compressible zone 140 could replace the annular rim 40 to act as the elastic element for biasing the movable element 30 against the body 20.

The dispensing head 118, of FIG. 8 may be used and cleaned in a manner similar to the manner in which the dispensing head 18 is used and cleaned.

It will be apparent to those skilled in the art that various modifications and variations can be made to the structure. Thus, it should be understood that the invention is not limited to the examples discussed in the specification. Rather, the present invention is intended to cover modifications and variations.

What is claimed is:

1. A dispensing head for actuating a dispensing element associated with a container and for dispensing product from the container, the dispensing head comprising:
a body configured to be mounted on the container, the body at least partly defining a feed channel;
a movable element having a portion defining a dispensing orifice, the movable element being movable between a first position, in which the dispensing orifice is in fluid communication with the feed channel, and a second position, in which the dispensing orifice lacks fluid communication with the feed channel; and
an elastic element configured to cause at least one of the portion of the movable element and a part of the body to be elastically biased against the other of the portion of the movable element and the part of the body when the movable element is in the first position.

2. The dispensing head of claim 1, wherein the dispensing orifice and an exit end of the feed channel define a product exit path, and wherein the elastic element is configured to exert a force substantially parallel to the product exit path.

3. The dispensing head of claim 2, wherein the elastic element is configured to elastically bias said at least one of the portion of the movable element and the part of the body in a direction substantially parallel to the product exit path.

4. The dispensing head of claim 1, wherein the portion of the movable element comprises a spray nozzle.

5. The dispensing head of claim 1, further comprising a post defining at least some of an exit end portion of the feed channel.

6. The dispensing head of claim 5, wherein the post comprises said part of the body.

7. The dispensing head of claim 6, wherein the post has a surface contacting the portion of the movable element when the movable element is in the first position.

8. The dispensing head of claim 5, wherein the post at least partially defines a swirl chamber.

9. The dispensing head of claim 8, wherein the post and the portion of the movable element cooperate to define the swirl chamber when the movable element is in the first position.

10. The dispensing head of claim 5, wherein the post projects from a surface of the body facing in substantially the same direction as the dispensing orifice.

11. The dispensing head of claim 5, wherein the post comprises the elastic element.

12. The dispensing head of claim 5, wherein the post comprises the elastic element and the part of the body.

13. The dispensing head of claim 1, wherein the elastic element is integral with the movable element.

14. The dispensing head of claim 13, wherein the elastic element comprises an elastically stretchable membrane arranged substantially around a perimeter of the portion of the movable element defining the dispensing orifice.

15. The dispensing head of claim 14, wherein the membrane comprises a substantially annular element.

16. The dispensing head of claim 5, wherein the elastic element comprises an elastically stretchable membrane arranged substantially around a perimeter of the portion of the movable element defining the dispensing orifice, and wherein the elasticity of the membrane is configured so that, when the movable element is in the first position, the portion of the movable element defining the dispensing orifice is biased elastically against the post.

17. The dispensing head of claim 1, wherein the elastic element is integral with the body.

18. The dispensing head of claim 5, wherein the elastic element is integral with the post and is configured to allow the post to be at least partly elastically compressible in a direction substantially parallel to a product exit path defined by the dispensing orifice and an exit end of the feed channel.

19. The dispensing head of claim 1, wherein the elastic element comprises an elastomeric material.

20. The dispensing head of claim 19, wherein the elastomeric material comprises at least one of a thermoplastic elastomer of polyester urethane; polybutadiene; bromobutyl rubber; chlorobutyl rubber; chlorinated polyethylene; a copolymer of polyesteraramide; a copolymer of polyester glycol; polychloroprene; chlorosulphonated polyethylene; a copolymer of at least ethylene and methylacrylate; a terpolymer of at least ethylene, propylene, and a diene; a copolymer of at least ethylene and propylene; polyether urethane; a fluorocarbonated copolymer; a fluorocarbonated terpolymer; butyl rubber; polyisoprene; nitrile rubber; polyurethane; phenyl-methylsilicone; vinyl-methylsilicone; a copolymer of styrene-butadiene; a block copolymer of styrene-butadiene; a block copolymer of styrene-butadiene-butylene-styrene; a block copolymer of styrene-isoprene; synthetic rubber; polysulphides; thermoplastic rubber; elastomeric thermoplastic polyolefin derivative; thermoplastic polyurethane; polyvinyl silicone; and a latex of at least one copolymer of butadiene-styrene-2-vinylpyridine.

21. The dispensing head of claim 19, wherein the dispensing head is produced by bi-injection of a thermoplastic elastomer forming the elastic element, and a nonelastomeric material forming a remainder of the dispensing head.

22. The dispensing head of claim 1, wherein at least part of the elastic element is less thick than at least a portion of the dispensing head in contact and integral with the elastic element.

23. The dispensing head of claim 1, further comprising a sealing system configured to create a substantially leak-proof seal between the body and the movable element.

24. The dispensing head of claim 23, wherein the sealing system comprises an elastic sealing element configured to protrude from at least one of the body and the movable element so as to be compressed between the movable element and the body when the movable element is in the first position to create the leak-proof seal.

25. The dispensing head of clam 24, wherein the sealing element is located on the body.

26. The dispensing head of claim 24, wherein the sealing element is located on the movable element.

27. The dispensing head of claim 23, wherein the sealing system comprises a flange located on one of the body and the movable element, and a complementary groove located on the other of the body and the movable element, wherein the flange and the groove are configured to mate to form the substantially leak-proof seal.

28. The dispensing head of claim 1, wherein the movable element and body are coupled to one another so that the movable element moves between the first position and the second position via a pivot movement about an axis substantially perpendicular to a product exit path defined by the dispensing orifice and an exit end portion of the feed channel.

29. The dispensing head of claim 1, wherein the movable element is attached to the body via a hinge.

30. The dispensing head of claim 29, wherein the hinge comprises at least one of a film hinge and a journal hinge.

31. The dispensing head of claim 1, further comprising a fastening member configured to temporarily fasten the movable element in the first position.

32. The dispensing head of claim 1, wherein the movable element is coupled to the body when the movable element is in both the first position and second position.

33. The dispensing head of claim 1, wherein the movable element is coupled to the body during movement between the first position and the second position.

34. The dispensing head of claim 13, wherein the portion of the movable element defining the dispensing orifice further comprises a swirl chamber.

35. The dispensing head of claim 1, wherein the body is configured to be mounted on the dispensing element.

36. The dispensing head of claim 1, wherein the part of the body defines at least some of an exit end portion of the feed channel.

37. The dispensing head of claim 1, wherein the body and the movable element cooperate to define at least some of the feed channel when the movable element is in the first position, and wherein said at least some of the feed channel may be cleaned when the movable element is in the second position.

38. An assembly for packaging and dispensing product, comprising:
a container associated with an actuatable dispensing element; and
the dispensing head of claim 1 mounted on the container.

39. The assembly of claim 38, further comprising a product contained in the container, wherein the product comprises a cosmetic product.

40. The assembly of claim 38, wherein the dispensing element comprises at least one of a valve and a pump.

41. The assembly of claim 38, wherein the dispensing element is configured to be movable to cause actuation of the dispensing element.

42. The assembly of claim 38, wherein the dispensing head is in the form of a push button.
